(19) United States
(12) Patent Application Publication
(10) Pub. No.: US 2005/0160779 A1
(43) Pub. Date: Jul. 28, 2005

(54) Fertilizer

(76) Inventors: Armin Jussen, Simmerath (DE); Marc Jussen, Aachen (DE)

Correspondence Address: Friedrich Kueffner, 317 Madison Avenue, Suite 910, New York, NY, 10017, US

(21) Appl. No.: 10/481,557

(22) PCT Filed: Jun. 19, 2002
(86) PCT No.: PCT/DE02/02246

(30) Foreign Application Priority Data
Jun. 20, 2001 (DE) 101 29 385.2

(51) Int. Cl. C05F 1/00

(52) U.S. Cl. 71/11

(57) ABSTRACT

The invention relates to a novel fertilizer comprised of treated silt, treated liquid manure and of different filling or supporting materials.

The present invention refers to soil material.

Natural soil material is known. Nevertheless, it is not everywhere available in sufficient quantities, or is being removed by erosion, washed out and/or leached out.

It is the object of the present invention to remedy this situation and propose a soil material, which can be produced easily and at convenient prices, and is fertile and quite adequate for the cultivation of plants.

This object is solved in accordance with a feature of claim 1. Advantageous versions are an object of the dependent claims.

The essence of the invention is the recognition that substances are incident in great quantities, which cannot be used as soil material isolated, however in the combination indicated here. These substances are a) harbor slush treated, b) treated slurry and c) adequate filler material.

Harbor Slush

Harbor slush comprises especially sediments deposited in the harbor basin, sediments along or close to see routes, sediments at river mouths or similar points. Harbor slush is usually affected by poisonous organic tin compounds. Treatments, such as the traditional unaffected material resulting from harbor dredges, storage rearrangement, harrowing, discharging, rinsing, etc., are excluded in view of the ecotoxicity factor. For the permanent solution of said problems, a decontamination process was therefore developed
see WO 01/16032. With this procedure, a safe, fast and conveniently priced decontamination of harbor slush, especially harbor slush affected with organic tin compounds, may be accomplished by means of electroflotation. Consequently, harbor slush no longer represents an environmental risk.

Decontaminated harbor slush is a strongly solid and heavy clay soil with small granulation. In view of its high loam portion, the material is no longer dragged by the wind. In addition, the soil has a very high water storage capacity.

Harbor Slush Treatment

By means of oxidation procedures through radical oxygen, generated in the reaction cell, the poisonous tributyl tin is dissociated and transferred into non-poisonous organic compounds. This is also applicable for other organic tin compounds and other poison. In addition, heavy metals and other CSB/BSB-relevant substances are oxidized. Simultaneously, the mixture of water/solid material is floculated and can be separated.

Harbor slush is thus decontaminated at an advantageous cost and in a simple fashion and a solid clay soil will be obtained. This is a new raw material, which is not subject to the conventional waste norms. After the treatment, the filtrate evidences quite low values as far as oxygen requirements are concerned. The remaining solution is exempt of TBT and heavy metals and features clearly lower AOX-, TOC- and mineral oil KW values. The disposal problem is solved, an elimination at special waste dumping sites no longer is required.

The flocs are pumped into a filter press or mud press and are additionally drained. The clean water is exempt of harmful materials, does no longer affect the environment and may be introduced into the harbor basin without any additional treatment or processing step.

Slurry

Slurry is a natural fertilizer, easy to be processed after undergoing a treatment.

The cow or pork slurry is being thickened with separators, so that all good fertilizing properties are being preserved. The remaining water is subject to subsequent treatment, so that it can be utilized in the future.

Slurry Treatment

In a first step, the slurry is treated by means of centrifuges or helical presses. The solid substances thus obtained may be subsequently used. The basic slurry is separated into solid substances and liquid. Heavy metals and other CSB/BSB-relevant substances are oxidized (see WO 01/17912). A solid utility fertilizer is obtained. The dried solid substance contains large quantities of nitrate and phosphate and consequently offers good fertilizing properties.

It is being mixed with harbor slush and structural material (and others) and results in the new soil. The separated water may be destined to other uses. The used water is no longer subject to the slurry norms and is free of harmful substances and: may be channeled to the public channel net without any additional preparation or processing measures.

The flocs are being pumped into a filter press and continue to be drained. According to an analysis from RWTH Aachen, the solid substance is classified as utility fertilizer.

“with reference to the materials examined by us, this is utility fertilizer in the sense of paragraph 1, section 2, Fertilizer Law from 15. November 1977. (BGB 1S.2134, finally altered by Law to change Fertilizer Law, dated 17 Dec. 1999 (BGB.I.i S2451)”.

Filtration of the flocculated residual waters is normally accomplished in centrifuges or chamber filter presses. A separation between water and filtrate takes place here.

Normally, the filter cake evidences a portion of water of 60% to 40% minimum.

Filler Material

The substrate is designed to improve the soil granulation quality. The soil is thus submitted to a better ventilation and has better properties for plant cultivation. Harbor slush and slurry alone cannot be used as soil material, since they feature an insufficient grain size distribution. A soil consisting only of these components would be too solid. With the use of excessive slurry, excess fertilizing phenomena may also become apparent.

Harbor slush and treated slurry, according to requirements, are being mixed with different materials. This substract may be of different quality. One can imagine sand, sandy soil or other unfertile soil material. This may be removed directly at the location, where unfertile land is being transformed into fertile arable land or into meadowy areas.

The mixture relationship may be varied, according to requirements. In the average, one may consider the following values. These may vary, in individual cases, up to 30%.

Harbor slush: slurry: substrate 1:1:2

1. Soil material, consisting of a mixture of treated harbor slush, treated slurry and filler material.

2. Soil material according to claim 2, consisting of a mixture of 15-35% treated harbor slush, 15-35% treated slurry and 35-65% filler material.

3. Soil material according to claim 2, consisting of a mixture of 20-30% treated harbor slush, 20-30% treated slurry and 40-60% filler material.

4. Soil material according to claim 3, consisting of a mixture of 25% treated harbor slush, 25% treated slurry and 50% filler material.

5. Soil material according to one of the preceding claims, characterized in that said harbor slush is especially decontaminated from organic tin compounds.

6. Soil material according to one of the preceding claims, characterized in that slurry is largely drained, being thus present in the form of solid material.

7. Soil material according to one of the preceding claims, characterized in that slurry only contains heavy metals and other CSB/BSB-relevant substances in oxidized form.

8. Soil material according to claim 6 or 7, characterized in that the water portion of the slurry represents 40-60%.

9. Soil material according to one of the preceding claims, characterized in that the filler material is sand, sandy or unfertile soil material ou a mixture of these materials.
